(19) United States
(12) Patent Application Publication
(10) Pub. No.: US 2025/0111484 A1
(43) Pub. Date: Apr. 3, 2025

(54) IMAGE BLUR CORRECTION CONTROL APPARATUS, CONTROL METHOD OF THE SAME, AND IMAGING APPARATUS

(71) Applicant: CANON KABUSHIKI KAISHA, Tokyo (JP)

(72) Inventors: YU NARITA, Kanagawa (JP); RYUICHIRO YASUDA, Tokyo (JP)

(21) Appl. No.: 18/899,755

(22) Filed: Sep. 27, 2024

(30) Foreign Application Priority Data
Sep. 28, 2023 (JP) 2023-168874

(51) Int. Cl. G06T 5/70; G06T 7/70

(52) U.S. Cl. CPC G06T 5/70; G06T 7/70

(57) ABSTRACT

A control apparatus includes an object detection unit configured to detect an object and output information about the detected object, a calculation unit configured to calculate an object blur correction amount, an information detection unit configured to detect information in a background as background information and output the background information, a first setting unit configured to set a first direction, an adjustment unit configured to adjust the object blur correction amount so that an object blur correction amount in a second direction is more limited than that in the first direction, and a control unit configured to control blur correction so as to bring the position of the object closer to the target position based on the adjusted object blur correction amount, wherein the first direction is set based on the background information.

### TECHNICAL FIELD

The aspect of the embodiments relates to an image blur correction control apparatus, a method for controlling the same, and an imaging apparatus.

### DESCRIPTION OF THE RELATED ART

An imaging apparatus such as a digital camera corrects an object blur caused by a movement of an object such as a person in addition to a shake applied to the imaging apparatus such as a camera shake caused by a user holding the imaging apparatus.

In object blur correction, if an imaging apparatus constantly attempts to correct an object blur in horizontal and vertical directions, a background may blur, resulting in a video with degraded quality and a feeling of strangeness. For example, in a scene where a person is kicking the ground and jumping, an attempt to correct an object blur in the vertical direction (gravity direction) cancels out the movement of the object in the vertical direction by the jump and instead causes a background to vibrate in the vertical direction, resulting in a feeling of strangeness.

According to Japanese Patent Application Laid-Open No. 2021-100239, a technique for tracking an object in a predetermined direction while suppressing tracking of the object in other directions in order to keep a movement of the object in the vertical direction by a jump in an image to be captured is discussed.

However, it has become clear that there may be a scene where the technique according to Japanese Patent Application Laid-Open No. 2021-100239 cannot address the above-described feeling of strangeness through study by inventors of the present application.

### SUMMARY

According to an aspect of the embodiments, a control apparatus includes an object detection unit configured to detect an object from an input image and output information about the detected object, a calculation unit configured to calculate a correction amount based on a position of the detected object in the input image and a target position set in the input image, an information detection unit configured to detect information included in a background from the input image as background information and output the background information, a first setting unit configured to set a first direction in which object blur correction is performed from among a plurality of directions, an adjustment unit configured to adjust the object blur correction amount so that an object blur correction amount in a second direction is more limited than an object blur correction amount in the first direction, and a control unit configured to control blur correction so as to bring the position of the object closer to the target position based on the adjusted object blur correction amount, wherein the first setting unit sets the first direction based on the background information.

Other aspects of the disclosure will be described in exemplary embodiments described below.

Further features of the disclosure will become apparent from the following description of exemplary embodiments with reference to the attached drawings.

### BRIEF DESCRIPTION OF THE DRAWINGS

FIG. 1 is a block diagram illustrating a configuration of an imaging apparatus according to a first exemplary embodiment.

FIG. 2 is a flowchart illustrating processing executed according to the first exemplary embodiment.

FIG. 3 illustrates a method for calculating an object blur correction amount.

FIGS. 4A to 4D illustrate a method for adjusting an object blur correction amount.

FIG. 5 is a block diagram illustrating a configuration of an imaging apparatus according to a second exemplary embodiment.

FIG. 6 is a flowchart illustrating processing executed according to the second exemplary embodiment.

### DESCRIPTION OF THE EMBODIMENTS

Exemplary embodiments of the disclosure will be described in detail below with reference to the attached drawings. The following exemplary embodiments are not meant to limit the scope of the disclosure as encompassed by the appended claims. A plurality of features is described in the exemplary embodiments, but not all of these features are essential to the disclosure, and the plurality of features may be arbitrarily combined. The same or similar components in the attached drawings are denoted by the same reference numerals, and redundant description will be omitted.

According to a first exemplary embodiment, an imaging apparatus is described that is provided with an image blur correction control apparatus that sets a direction in which an object blur is corrected and a direction in which object blur correction is weakened based on a panning direction of the imaging apparatus and background information included in an image captured by the imaging apparatus. Weakening object blur correction includes not performing the object blur correction, in other words, setting an object blur correction amount to zero. Weakening object blur correction means limiting the object blur correction amount in the relevant direction more than the object blur correction amount in the direction in which the object blur is corrected.

### (Overall Configuration of Imaging Apparatus)

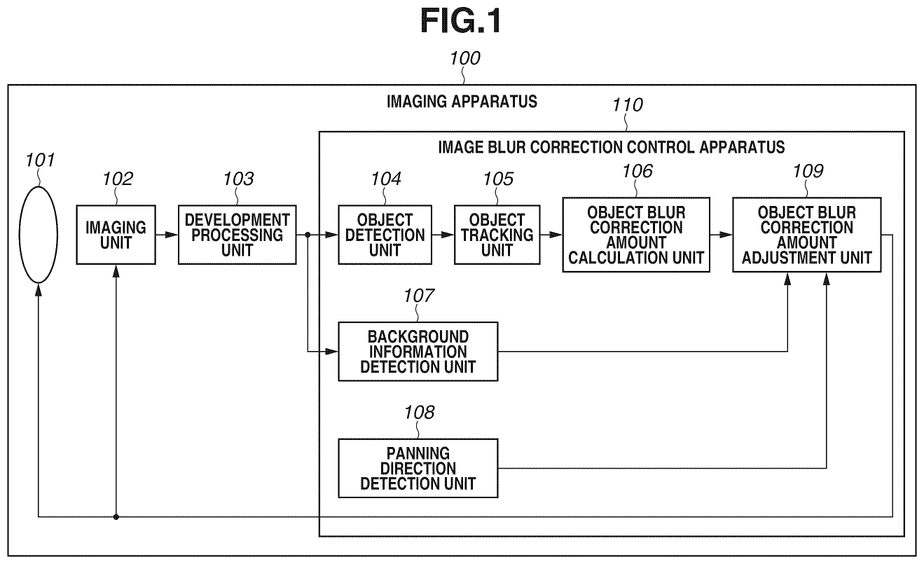

FIG. 1 is a block diagram illustrating an example of a configuration of an imaging apparatus according to the present exemplary embodiment. In FIG. 1, an imaging apparatus 100 includes a lens, but the configuration of the imaging apparatus 100 is not limited to this configuration and may include an interchangeable lens. Each configuration in the imaging apparatus 100 is described.

The imaging apparatus 100 includes an optical system 101, an imaging unit 102, a development processing unit 103, and an image blur correction control apparatus 110. The optical system 101 includes an optical element such as a lens. According to the present exemplary embodiment, the optical system 101 includes a correction lens (not illustrated) that corrects an image blur by moving in a direction vertical to an optical axis.

An object image formed by the optical system 101 is converted into an image signal by the imaging unit 102. The imaging unit 102 includes an imaging element using a complementary metal oxide semiconductor (CMOS) sensor or the like and converts the object image from an optical signal to an electrical signal. The imaging element according to the present exemplary embodiment is disposed in a movable unit so that an image blur can be corrected by moving in the direction vertical to the optical axis of the optical system 101, but the disclosure is not limited to this configuration.

The development processing unit 103 performs development processing such as white balance processing, color (luminance and color difference signal) conversion, and gamma (γ) correction on an imaging signal read out from the imaging element included in the imaging unit 102 and outputs the processed signal as an image.

The image blur correction control apparatus 110 includes an object detection unit 104, an object tracking unit 105, an object blur correction amount calculation unit 106, a background information detection unit 107, a panning direction detection unit 108, and an object blur correction amount adjustment unit 109.

The object detection unit 104 performs object detection processing for detecting a specific object on an input image from the development processing unit 103 and outputs detected object information.

The object tracking unit 105 tracks a position of an object to be a target of the object blur correction among the objects detected by the object detection unit 104. Tracking refers to following the position of the object in the input image.

The object blur correction amount calculation unit 106 calculates an object blur correction amount based on the position of the object tracked by the object tracking unit 105 in the input image and a target position set in the input image. The calculated object blur correction amount is a provisional object blur correction amount because it may be adjusted by the object blur correction amount adjustment unit 109.

The background information detection unit 107 performs background detection processing for detecting a background on the input image from the development processing unit 103 and detects information about the detected background as background information. Specifically, the background information includes at least one of information about a boundary included in the background, information about a contrast of the background, and a type of the background.

The panning direction detection unit 108 detects a direction in which a user moves the imaging apparatus 100 to track the object, namely the panning direction, based on a shake amount applied to the imaging apparatus 100. The panning direction can be assumed as the direction in which the user moves the imaging apparatus 100 to capture an image of the object and thus can be assumed as a direction in which the user wants to correct the object blur.

The object blur correction amount adjustment unit 109 adjusts the object blur correction amount calculated by the object blur correction amount calculation unit 106 based on outputs from the background information detection unit 107 and the panning direction detection unit 108. The object blur correction amount adjustment unit 109 sets the direction in which the object blur is corrected (hereinbelow, may be referred to as a first direction) based on the background information output from the background information detection unit 107 and the panning direction output from the panning direction detection unit 108. The object blur correction amount adjustment unit 109 adjusts the object blur correction amount so that the object blur correction amount in a second direction different from the first direction is more limited than the object blur correction amount in the first direction. Limiting means that the object blur correction amount after adjustment by the object blur correction amount adjustment unit 109 is less than the object blur correction amount before adjustment. A specific method for limiting the object blur correction amount does not particularly matter, and, for example, methods for narrowing a frequency band included in the object blur correction amount, reducing an upper limit value of the object blur correction amount, and reducing a gain can be used.

In a scene where a bird or an airplane is flying and there is a sea horizon in the background, correcting an object blur in the vertical direction causes the sea horizon to vibrate in the vertical direction, resulting in a feeling of strangeness.

Such a feeling of strangeness is particularly noticeable in a scene that includes a boundary such as the horizon or the sea horizon in the background, if the boundary vibrates in a direction other than a direction in which the imaging apparatus 100 is moved to track the object. On the other hand, even in a scene where a bird or an airplane is flying, if the scene does not include the boundary in the background with a completely blue sky or the like, correcting the object blur in the vertical direction does not cause a feeling of strangeness, rather, the object remains stably within the screen, resulting in a preferable image. For this reason, according to the present exemplary embodiment, the object blur correction amount is adjusted based on the background information.

The correction lens and/or the imaging element in the optical system 101, which are optical blur correction units, are moved in the direction vertical to the optical axis of the optical system 101 based on the object blur correction amount adjusted by the object blur correction amount adjustment unit 109 to adjust a relative position between the imaging element and the object image. Accordingly, it is possible to perform the object blur correction that brings the position of the object in the image captured by the imaging apparatus 100 closer to the target position. Instead of performing optical blur correction by moving the correction lens or the imaging element, electronic blur correction may be performed, or object blur correction may be performed by combining optical blur correction and electronic blur correction. The object blur correction amount adjustment unit 109 can control the object blur correction by outputting the object blur correction amount adjusted by at least one of the optical blur correction unit and an electronic blur correction unit.

### (Object Blur Correction Processing In Imaging Apparatus)

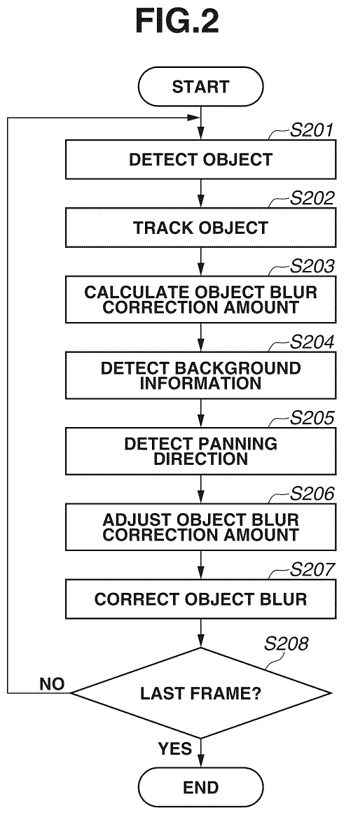

Object blur correction control processing performed in the imaging apparatus 100, which is configured as described above, is described with reference to a flowchart illustrated in FIG. 2. FIG. 2 is a flowchart illustrating an example of processing of an entire object blur correction function. An object tracking function described below is performed by the image blur correction control apparatus 110 unless otherwise specified explicitly. The processing in the flowchart in FIG. 2 is started with an instruction to start the object blur correction function by an operation on a start button or a menu of the object blur correction function.

In a case where the object blur correction function is started, in step S201, the object detection unit 104 performs detection processing for detecting a specific object on the input image from the development processing unit 103 and outputs information about the detected object as object information. The specific object is itself an object that can move, and a typical example is a person's face. In a case where a face is to be detected, any known face detection method can be used. Publicly known technology for face detection includes a method for using knowledge about a face (skin color information and parts such as eyes, nose, and mouth) and a method for configuring a classifier for face detection using a learning algorithm typified by a neural network. These methods may be combined to perform face detection to improve detection accuracy. In addition to a person's face, a human body, an animal, a vehicle, and the like may be detected as a specific object, and a plurality of types of objects may be detected as specific objects. The object information to be output includes at least one of a position of the detected object, a size, a type, and the number of the objects.

In step S202, the object tracking unit 105 acquires a position in the input image of one of the objects detected by the object detection unit 104 in step S201 and tracks the object. The object can be tracked using known template matching in which a partial image including the object that is a target of the object blur correction is used as a template. In a case where a plurality of objects is detected in step S201, the object to be the target of the object blur correction may be automatically selected by the object tracking unit 105 or selected based on a user operation. In a case where the object is automatically selected, the object that is considered to be the most important may be selected, and, for example, priority of selection may be given to an object that is larger in size, located closer to the center of the image, and has a higher reliability in object detection.

In the second and subsequent frames, the object tracked in the immediately preceding frame is tracked. In a case where the object can no longer be tracked, the target of the object blur correction may be selected and tracked again from the objects detected in step S201. Detection processing for detecting a specific object in step S201 may be performed for each frame.

In step S203, the object blur correction amount calculation unit 106 calculates a provisional object blur correction amount based on the position in the input image of the object tracked by the object tracking unit 105 in step S202 and the target position set in the image. The target position may be a position set in advance in the image, may be automatically set by the image blur correction control apparatus 110, or may be set at an arbitrary position by a user.

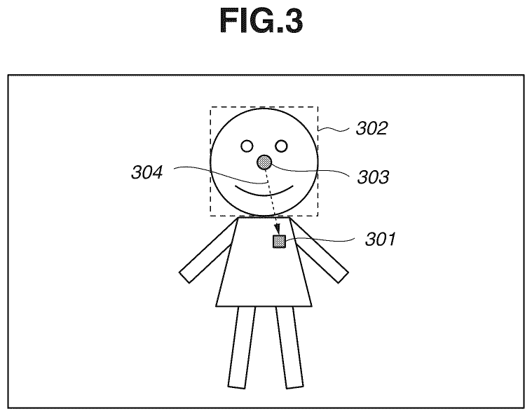

A method for calculating the object blur correction amount is described with reference to FIG. 3. FIG. 3 illustrates an example in which a target position 301 is set in the center of the image and a face area 302 of a person is the specific object detected in step S202. According to the present exemplary embodiment, the object blur correction amount calculation unit 106 calculates a difference between coordinates of the center of gravity 303 of the face area 302 and coordinates of the target position 301 as the object blur correction amount. Due to influence of image noise and object detection accuracy, the position of the detected object generally has an error. Thus, in one embodiment, a low-pass filter (hereinbelow, referred to as LPF) is applied to the position of the specific object to be detected (here, the coordinates of the center of gravity 303) or the object blur correction amount and calculate a low-frequency component as a provisional object blur correction amount.

In step S204, the background information detection unit 107 performs background detection processing for detecting the background on the input image from the development processing unit 103 and outputs information about the detected background as background information. The background is itself an object that does not move, and the background information includes at least one of a boundary included in the background, a contrast of the background, and a type of the background.

The boundary in the background can be detected using a trained model or a known edge detection method such as the Canny algorithm. According to the present exemplary embodiment, boundaries in the horizontal and vertical directions are detected.

The contrast of the background can be calculated from maximum and minimum luminance values of the background. For example, the contrast of the background can be detected by acquiring respective luminance profiles in the horizontal and vertical directions on an arbitrary line in the image where the specific object is not present. If a difference between the maximum luminance value and the minimum luminance value in the luminance profile is a predetermined threshold value or greater, it can be determined that a boundary exists, and if the difference is less than the predetermined threshold value, it can be determined that a boundary does not exist. A boundary in the vertical direction can be detected from the luminance profile in the horizontal direction, and a boundary in the horizontal direction can be detected from the luminance profile in the vertical direction.

The type of background, such as sky, ground, or a water surface, is determined for each area of the image using a trained model. If the image includes a plurality of types of background, it is determined that a boundary is highly likely to exist. For example, if sky and ground are included in the image, it is determined that a horizon exists, and if sky and a water surface are included, it is determined that a sea horizon exists. A direction of the boundary such as the horizon or the sea horizon can be determined from a positional relationship of each area.

In step S205, the panning direction detection unit 108 detects the panning direction based on a shake amount of the imaging apparatus 100. The shake amount applied to the imaging apparatus 100 can be determined using, for example, a detection result of an inertial sensor, such as a gyro sensor or an angular velocity sensor, disposed in the imaging apparatus 100. According to the present exemplary embodiment, a shake angle acquired by integrating an angular velocity detected by the gyro sensor is used as the shake amount, and the shake angle in the horizontal direction and the shake angle in the vertical (perpendicular) direction are each compared with a threshold value. As a result of the comparison, the direction in which the acquired shake angle is greater than the threshold value is detected as the panning direction. If the shake angle in the horizontal direction is the threshold value or greater, the panning direction is detected as the horizontal direction. If the shake angle in the vertical direction is the threshold value or greater, the panning direction is detected as the vertical direction. If both the shake angles in the horizontal and vertical directions are the threshold value or greater, the panning directions are detected as the horizontal and vertical directions. If both the shake angles in the horizontal and vertical directions are less than the threshold value, the panning direction is detected as none.

The threshold values in the horizontal and vertical directions may be the same or different. The threshold value can be set appropriately and may also be set based on an angle of view. If the angle of view in the horizontal direction is set as the threshold value in the horizontal direction, it is possible to determine that panning is performed in a case where panning more than the angle of view is performed in the horizontal direction (in a case where panning is performed to an extent that the background in the horizontal direction is changed before and after panning).

In step S206, the object blur correction amount adjustment unit 109 adjusts the object blur correction amount calculated in step S203 based on the background information detected in step S204 and the panning direction detected in step S205.

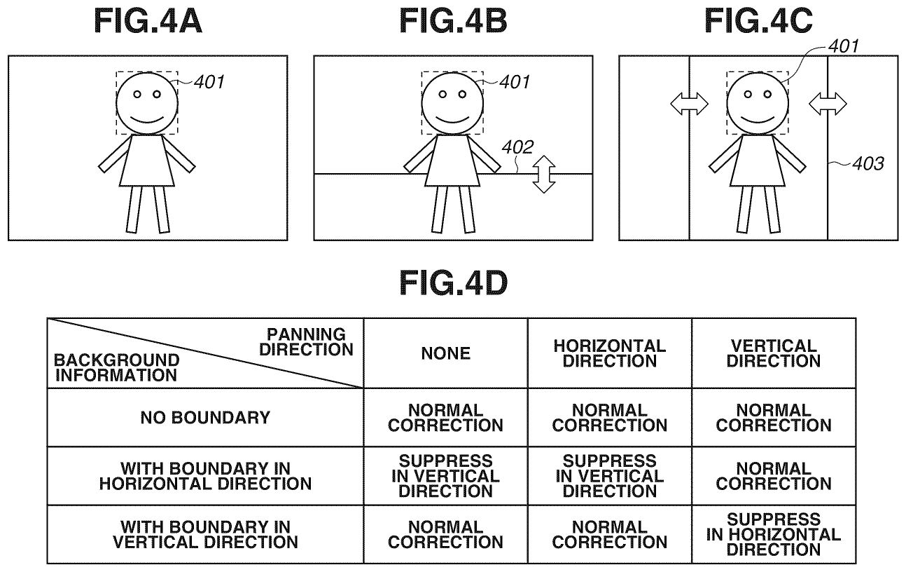

An example of an adjustment method is described with reference to FIGS. 4A to 4D. FIG. 4A illustrates a case where a specific object (face area) 401 exists and a boundary does not exist in the background. In this case, there is no boundary in the background that is a cause of a feeling of strangeness, so that the object blur correction amount calculated in step S203 can be used as it is regardless of the panning direction detected in step S205. Accordingly, the center of gravity of the specific object 401 is controlled to approach the target position in both the horizontal and vertical directions. FIG. 4B illustrates a case where the specific object 401 exists and a boundary 402 in the horizontal direction exists in the background. In this case, if the boundary 402 vibrates in the vertical direction in a case where the object blur is corrected, a feeling of strangeness occurs. Thus, the object blur correction amount in the horizontal direction is not suppressed, but the object blur correction amount in the vertical direction is suppressed, so that the object blur correction amount in the vertical direction is more limited than the object blur correction amount in the horizontal direction. However, in a case where the panning direction is the vertical direction, it is assumed that a user intentionally moves the imaging apparatus 100 to correct the object blur in the vertical direction, so that the object blur correction amount in the vertical direction is not suppressed, either. In other words, in a case where the boundary in the horizontal direction exists in the background information and the panning direction is the horizontal direction, the object blur correction amount is adjusted so that the object blur correction amount in the vertical direction is more limited than the object blur correction amount in the horizontal direction.

FIG. 4C illustrates a case where the specific object 401 exists and a boundary 403 in the vertical direction exists in the background. In this case, if the boundary 403 vibrates in the horizontal direction in a case where the object blur is corrected, a feeling of strangeness occurs. Thus, the object blur correction amount in the vertical direction is not suppressed, but the object blur correction amount in the horizontal direction is suppressed, so that the object blur correction amount in the horizontal direction is more limited than the object blur correction amount in the vertical direction. However, in a case where the panning direction is the horizontal direction, it is assumed that the user intentionally moves the imaging apparatus 100 to correct the object blur in the horizontal direction, so that the object blur correction amount in the horizontal direction is not suppressed, either. In other words, in a case where the boundary in the vertical direction exists in the background information and the panning direction is the vertical direction, the object blur correction amount is adjusted so that the object blur correction amount in the horizontal direction is more limited than the object blur correction amount in the vertical direction.

FIG. 4D illustrates a table summarizing examples of relationships of background information, panning direction, and object blur correction. In this way, in a case where the direction of the boundary existing in the background matches the panning direction, that direction is set as a first direction in which the object blur correction is performed and a direction vertical to that direction is set as a second direction in which the object blur correction is limited. In a case where no boundary exists, both the horizontal and vertical directions are set as the first direction in which the object blur correction is performed regardless of the panning direction, and neither direction is set as the second direction in which the object blur correction is limited. At this time, the object blur correction amount is not adjusted in each direction based on the background information.

Generally, a feeling of strangeness caused by object blur correction is more likely to occur in the vertical direction (gravity direction) than the horizontal direction. Thus, in FIG. 4D, in a case where a boundary in the horizontal direction exists, even if there is no panning direction (panning is not performed in either direction), the horizontal direction is set as the first direction and the vertical direction is set as the second direction, thereby limiting the object blur correction in the vertical direction. On the other hand, in a case where a boundary in the vertical direction exists, both the horizontal and vertical directions are set as the first direction in a state where there is no panning direction.

As described above, it can be considered that a feeling of strangeness caused by a movement of a boundary is greater as the contrast of the background is higher. Thus, as the contrast is higher, the object blur correction amount in the second direction may be more strongly limited.

As described above, in a case where a plurality of types of the background is included, a boundary is highly likely to exist, and it can be considered that a feeling of strangeness caused by a vibration of the boundary is significant. Thus, as a larger number of types of the background are included in the image, the object blur correction amount in the second direction may be more strongly limited.

A method for limiting the object blur correction amount does not particularly matter, and if limit on the object blur correction amount in the second direction is stronger than limit on the object blur correction amount in the first direction, the object blur correction amount in the first direction may also be limited. For example, in a case where the object blur correction amount is large and cannot be fully corrected, the object blur correction amount in the first direction may also be limited. Specific examples of a method for limiting the object blur correction amount include, for example, a method for multiplying the object blur correction amount by a gain for reducing it and a method for lowering a cutoff frequency of the LPF with respect to the object blur correction amount and narrowing the frequency band included in the object blur correction amount. There is also a method for lowering the upper limit of the object blur correction amount between frames.

As described above, the first and the second directions are set based on the background information about the captured scene and the panning direction, and the object blur correction amount is adjusted so that the object blur correction amount in the second direction is more limited than the object blur correction amount in the first direction. The object blur correction amount adjustment unit 109 outputs the object blur correction amount that is adjusted by at least one of the optical blur correction unit and the electronic blur correction unit. Accordingly, the object blur correction amount adjustment unit 109 controls the blur correction so that the position of the object that is a target of the object blur correction (hereinbelow, may be referred to as a target object) in the image approaches the target position. It is sufficient that the target object approaches the target position in at least one of the horizontal and vertical directions. In step S207, the blur correction is performed based on the object blur correction amount adjusted by the object blur correction amount adjustment unit 109 in step S206. As described above, the correction lens and the imaging unit 102 in the optical system 101, which are the optical blur correction units, and the electronic blur correction unit (not illustrated) can be used as blur correction units.

In step S208, the imaging apparatus 100 determines whether the processing is completed up to the last frame. In a case where the processing is not completed up to the last frame (NO in step S208), the processing proceeds to step S201.

The processing may proceed to step S202, and in a case where the object tracked in the previous frame is lost, the processing may return to step S201 and start over from object detection.

By the above-described processing, the object blur correction amount in a specific direction is adjusted based on the background information about the captured scene and a tracking direction, and thus the object blur correction can be performed without deteriorating the quality of the video.

The processing in steps S201 to S208 can all be performed in real time during imaging, but it does not necessarily have to be performed during imaging and may be performed during image reproduction using the electronic blur correction unit. For example, the captured image and the detection result of the shake amount of the imaging apparatus 100 (or the detection result of the panning direction) are recorded in a recording unit (not illustrated), and the processing in steps S201 to S208 is performed on the recorded image, so that the object blur correction can be performed at the time of reproducing the image. In addition to the image, the object information acquired by the object detection unit 104 may be recorded at the time of imaging so that the object detection does not need to be performed in reproducing the image.

According to the first exemplary embodiment, only an object blur is treated as a target of blur correction, but according to a second exemplary embodiment, blur correction is performed by taking into account an imaging apparatus shake (a camera shake), which is a shake of the imaging apparatus itself.

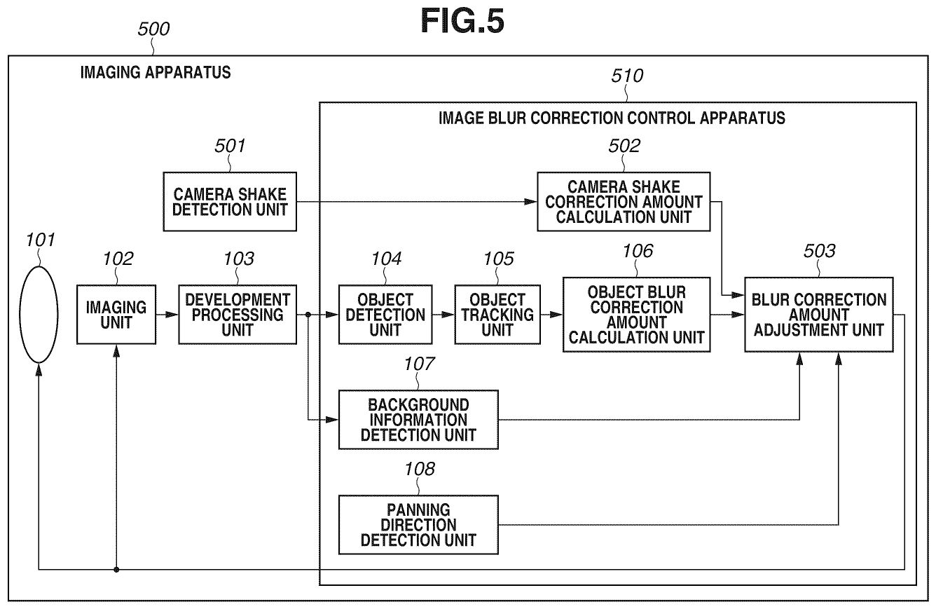

FIG. 5 is a block diagram illustrating an example of a configuration of an imaging apparatus 500 according to the present exemplary embodiment. In FIG. 5, components common to those illustrated in FIG. 1 are denoted by the same reference numerals illustrated in FIG. 1, and descriptions thereof are omitted. The imaging apparatus 500 according to the present exemplary embodiment includes a camera shake detection unit 501, a camera shake correction amount calculation unit 502, and a blur correction amount adjustment unit 503 in addition to the units illustrated in FIG. 1. According to the present exemplary embodiment, only the units that perform processing different from those according to the first exemplary embodiment are described.

The camera shake detection unit 501 detects a shake applied to the imaging apparatus 500 and outputs the shake detection result to an image blur correction control apparatus 510. Specifically, an inertial sensor such as an angular velocity sensor and an acceleration sensor can be used. In a case where a detection result of the inertial sensor is used for panning determination described in the first exemplary embodiment, the detection result of the camera shake detection unit 501 can be used.

The camera shake correction amount calculation unit 502 calculates a camera shake correction amount for correcting a camera shake based on the shake detection result detected by the camera shake detection unit 501. A known method can be used as a calculation method of the camera shake correction amount.

The blur correction amount adjustment unit 503 combines the object blur correction amount output from the object blur correction amount calculation unit 106 and the camera shake correction amount output from the camera shake correction amount calculation unit 502 to calculate a final blur correction amount. At this time, a combination ratio is adjusted based on the background information detected by the background information detection unit 107 and the panning direction detected by the panning direction detection unit 108, and thus it is possible to also fulfill a role of the object blur correction amount adjustment unit according to the first exemplary embodiment.

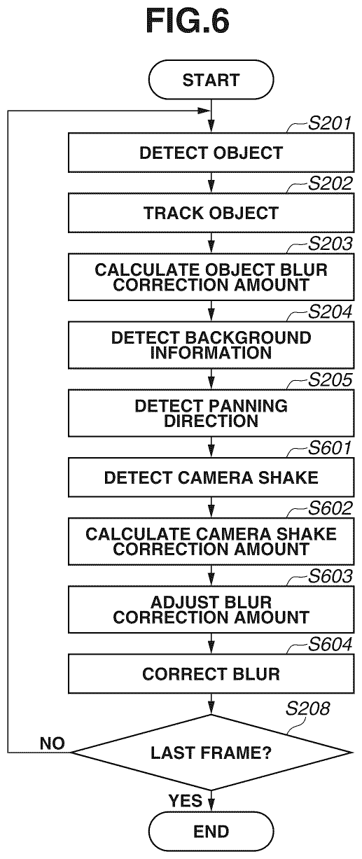

FIG. 6 is a flowchart illustrating image blur correction processing according to the second exemplary embodiment. In FIG. 6, steps common to those illustrated in FIG. 2 are denoted by the same reference numerals as those in FIG. 2, and descriptions thereof are omitted.

Processing in steps S201 to S205 is the same as that according to the first exemplary embodiment. After the panning direction detection processing in step S205 is completed, the processing proceeds to step S601.

In step S601, the camera shake detection unit 501 detects a shake applied to the imaging apparatus 500. Processing in step S601 may be executed at arbitrary timing before the processing in step S602 and may be executed before or after the processing in steps S201 to S205.

In step S602, the camera shake correction amount calculation unit 502 calculates a camera shake correction amount for correcting the shake detected in step S601. For example, if the camera shake correction amount calculation unit 502 is a gyro sensor, an angular velocity signal, which is a detection result of the gyro sensor, is integrated, and the sign is inverted to calculate the camera shake correction amount. Filtering processing or the like may be appropriately performed on the detection result of the gyro sensor.

In step S603, the blur correction amount adjustment unit 503 combines the object blur correction amount acquired in step S203 and the camera shake correction amount acquired in step S602 to calculate the final blur correction amount. At this time, the object blur correction amount is adjusted by adjusting a combination ratio (weight) of the object blur correction amount and the camera shake correction amount based on the background information detected in step S204 and the panning direction detected in step S205. In other words, a combination ratio of the object blur correction amount in the first direction in which the object blur correction is performed is set smaller than a combination ratio of the object blur correction amount in the second direction in which the object blur correction is suppressed. Accordingly, the object blur correction amount in the second direction is limited, and a feeling of strangeness caused by performing the object blur correction can be reduced. In one embodiment, the combination ratio is dynamically adjusted.

As a combination method, for example, there is a method for dividing the correction amount into frequency components and combining them. For example, LPF processing is applied to the object blur correction amount to extract a low-frequency component. Meanwhile, high-pass filter (hereinbelow, referred to as HPF) processing is applied to the camera shake correction amount to extract a high-frequency component. The low-frequency component of the object blur correction amount and the high-frequency component of the camera shake correction amount acquired in this manner are combined by weighting and adding them based on the background information and the tracking direction. The combination ratio can be controlled by substantially matching cutoff frequencies of the LPF and the HPF respectively in the horizontal and vertical directions and then changing the cutoff frequencies based on the background information and the panning direction. Specifically, based on the relationship between the background information and the panning direction illustrated in FIG. 4D, the cutoff frequencies of the LPF and the HPF are lowered in the second direction in which the object blur correction amount is suppressed than those in the first direction in which the object blur correction amount is not suppressed. Accordingly, the weight of the low-frequency component of the object blur correction amount becomes smaller, and the weight of the high-frequency component of the camera shake correction amount becomes larger, so that a camera shake correction effect can be strengthened by the amount limiting the object blur correction amount.

Instead of dividing the correction amount into frequency components and combining them, the correction amount may be combined using a gain. In this case, a gain of the object blur correction amount in the second direction may be set smaller than a gain of the object blur correction amount in the first direction. By setting a gain of the camera shake correction amount to (1—the gain of the object blur correction amount), the camera shake correction effect can be strengthened by the amount of limiting the object blur correction amount.

In step S604, the blur correction is performed based on the final blur correction amount (referred to as the blur correction amount after adjustment) acquired in step S603. As described above, the correction lens and the imaging unit 102 in the optical system 101, which are the optical blur correction units, and the electronic blur correction unit (not illustrated) can be used as the blur correction units. As in the first exemplary embodiment, instead of performing the processing in real time, the electronic blur correction unit may be used to perform blur correction during image reproduction.

By the above-described processing, the object blur correction amount and the camera shake correction amount are adjusted and combined based on the background information about the captured scene and the tracking direction, and thus the object blur correction and the camera shake correction can be performed without deteriorating the quality of the video.

A modification is described. According to the first and second exemplary embodiments described above, the panning direction detected by the panning direction detection unit 108 based on the shake amount applied to the imaging apparatus 100 is assumed as the direction in which a user wants to correct the object blur and is provisionally set as the direction in which the object blur is corrected. However, the direction in which the object blur is corrected may be set by a user input. In this case, the direction set by the user input is provisionally set as the direction in which the object blur is corrected, and if the provisionally set direction matches the direction of the boundary in the background, the provisionally set direction may be set as the first direction, and if not, the provisionally set direction and the direction of the boundary may be set as the first direction. For example, in a case where a user inputs that an object blur in the horizontal direction is to be corrected, if there is a boundary in the horizontal direction, the horizontal direction is set as the first direction, and the vertical direction is set as the second direction. On the other hand, if there is a boundary in the vertical direction, the horizontal and vertical directions are set as the first direction, and the second direction is not set. If there are no boundaries in the horizontal and vertical directions, both directions may be set as the first direction as illustrated in FIG. 4D, or a user input may be prioritized and only the horizontal direction may be set as the first direction.

According to the second exemplary embodiment, a shake of the imaging apparatus itself is described as a camera shake, but a source of the shake is not particularly limited, and a shake other than that transmitted from a user's hand may be a target of correction.

The aspect of the embodiments is not limited to an imaging apparatus being held by a user in his or her hand. For example, the aspect of the embodiments can also be applied to a case where an imaging apparatus is fixed to a vehicle that generates a vibration or to a building where a vibration may occur. A shake amount applied to an imaging apparatus, such as a vibration and a camera shake, is collectively referred to as an imaging apparatus shake amount, a correction amount for correcting an imaging apparatus shake is referred to as an imaging apparatus shake correction amount, and a unit that calculates the imaging apparatus shake correction amount is referred to as an imaging apparatus shake correction amount calculation unit.

The aspect of the embodiments can also be realized by executing following processing. More specifically, a program for realizing one or more functions of the above-described exemplary embodiments is supplied to a system or an apparatus via a network or a storage medium and one or more processors in a computer of the system or the apparatus reads and executes the program. The aspect of the embodiments can also be realized by a circuit (for example, an application specific integrated circuit (ASIC)) that realizes one or more functions.

The disclosure is not limited to the above-described exemplary embodiments, and various modifications and changes can be made without departing from the spirit and the scope of the disclosure. Therefore, the following claims are attached in order to publicize the scope of the aspect of the embodiments.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-168874, filed Sep. 28, 2023, which is hereby incorporated by reference herein in its entirety.

What is claimed is:

1. A control apparatus comprising:
an object detection unit configured to detect an object from an input image and output information about the detected object;
a first calculation unit configured to calculate an object blur correction amount based on a position of the detected object in the input image and a target position set in the input image;
an information detection unit configured to detect information included in a background from the input image as background information and output the background information;
a first setting unit configured to set a first direction in which object blur correction is performed from among a plurality of directions;
an adjustment unit configured to adjust the object blur correction amount so that an object blur correction amount in a second direction is more limited than an object blur correction amount in the first direction; and
a control unit configured to control blur correction so as to bring the position of the object closer to the target position based on the adjusted object blur correction amount,
wherein the first setting unit sets the first direction based on the background information.

2. The control apparatus according to claim 1, wherein the background information includes at least one of a boundary included in the background, a contrast of the background, and a type of the background.

3. The control apparatus according to claim 1, further comprising a second setting unit configured to set a direction in which the object blur correction is performed from among the plurality of directions,
wherein the first setting unit sets the first direction based on the direction in which the object blur correction is performed set by the second setting unit and the background information.

4. The control apparatus according to claim 3,
wherein the second setting unit sets the direction in which the object blur correction is performed based on a blur amount in each of the plurality of directions of an imaging apparatus that captures the input image, and
wherein the first setting unit sets the first direction based on the direction in which the object blur correction is performed set by the second setting unit and the background information.

5. The control apparatus according to claim 3, wherein the second setting unit sets the direction in which the object blur correction is performed based on a user operation.

6. The control apparatus according to claim 3, wherein, in a case where the direction in which the object blur correction is performed set by the second setting unit matches a direction of a boundary included in the background information, the direction set is set as the first direction.

7. The control apparatus according to claim 3, wherein, in a case where the direction in which the object blur correction is performed set by the second setting unit does not match a direction of a boundary included in the background information, the direction set and the direction of the boundary are set as the first direction.

8. The control apparatus according to claim 1, wherein, in a case where the first setting unit sets a plurality of directions as the first direction, the adjustment unit does not adjust the object blur correction amount different in each direction.

9. The control apparatus according to claim 2, wherein the adjustment unit more limits the object blur correction amount as the contrast of the background included in the background information is higher.

10. The control apparatus according to claim 2, wherein the adjustment unit more limits the object blur correction amount as a larger number of types of the background are included in the background information.

11. The control apparatus according to claim 1, further comprising a second calculation unit configured to acquire an imaging apparatus shake amount that is a shake amount applied to an imaging apparatus that captures the input image and calculate an imaging apparatus shake correction amount based on the imaging apparatus shake amount,
wherein the adjustment unit combines the object blur correction amount output from the first calculation unit and the imaging apparatus shake correction amount output from the second calculation unit to acquire a blur correction amount to be used by the control unit for controlling the blur correction, and adjusts the object blur correction amount by changing a ratio of the combining, and
wherein the control unit performs the blur correction based on the blur correction amount acquired by combining the object blur correction amount and the imaging apparatus shake correction amount.

12. The control apparatus according to claim 11, wherein the adjustment unit sets a combination ratio to be used in the combining of the object blur correction amount in the second direction smaller than a combination ratio of the object blur correction amount in the first direction to more limit the object blur correction amount in the second direction than the object blur correction amount in the first direction.

13. The control apparatus according to claim 12, wherein the adjustment unit increases the combination ratio of the imaging apparatus shake correction amount by an amount corresponding to reduction in the combination ratio of the object blur correction amount.

14. The control apparatus according to claim 1, wherein the adjustment unit adjusts the object blur correction amount by making a frequency band included in the object blur correction amount in the second direction narrower than a frequency band included in the object blur correction amount in the first direction.

15. The control apparatus according to claim 1, wherein the adjustment unit adjusts the object blur correction amount by making an upper limit value of the object blur correction amount in the second direction smaller than an upper limit value of the object blur correction amount in the first direction.

16. The control apparatus according to claim 1, wherein the adjustment unit adjusts the object blur correction amount by making a gain by which the object blur correction amount in the second direction is multiplied smaller than a gain by which the object blur correction amount in the first direction is multiplied.

17. The control apparatus according to claim 1, wherein, in a case where the object detection unit detects a plurality of objects, the first calculation unit calculates the object blur correction amount based on a position of a target object of object blur correction in the input image and the target position.

18. An imaging apparatus comprising:
an imaging unit;
an object detection unit configured to detect an object from an input image captured by the imaging unit and output information about the detected object;
a first calculation unit configured to calculate an object blur correction amount based on a position of the detected object in the input image and a target position set in the input image;
an information detection unit configured to detect information included in a background from the input image as background information and output the background information;
a first setting unit configured to set a first direction in which object blur correction is performed from among a plurality of directions;
an adjustment unit configured to adjust the object blur correction amount so that an object blur correction amount in a second direction different from the first direction is more limited than an object blur correction amount in the first direction; and
a control unit configured to control blur correction so as to bring the position of the object closer to the target position based on the adjusted object blur correction amount,
wherein the first setting unit sets the first direction based on the background information.

19. A method for controlling a control apparatus, the method comprising:
detecting an object from an input image and outputting information about the detected object;
calculating an object blur correction amount based on a position of the detected object in the input image and a target position set in the input image;
detecting information included in a background from the input image as background information and outputting the background information;
setting a first direction in which object blur correction is performed from among a plurality of directions;
adjusting the object blur correction amount so that an object blur correction amount in a second direction is more limited than an object blur correction amount in the first direction; and
controlling blur correction so as to bring the position of the object closer to the target position based on the adjusted object blur correction amount,
wherein the first direction is set based on the background information in the setting.
